(19) United States
(12) Patent Application Publication
(10) Pub. No.: US 2008/0266246 A1
(43) Pub. Date: Oct. 30, 2008

(54) TRAVERSING GRAPHICAL LAYERS USING A SCROLLING MECHANISM IN A PHYSICAL DESIGN ENVIRONMENT

(75) Inventors: Karl L. Ladin, Rochester, MN (US); Chun-Tao Li, Rochester, MN (US); Salvatore N. Storino, Rochester, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/739,911

(22) Filed: Apr. 25, 2007

(51) Int. Cl. G06F 3/048; G06F 15/00; G09G 5/08

(52) U.S. Cl. 345/156; 345/162

(57) ABSTRACT

Z-axis display navigation in the design automation process of physical design, development and manufacturing of integrated circuits includes pre-selecting, using a computer mouse connected to a computer workstation processor, viewable graphical layout layers desired by a design layout debugging operator to view during an integrated circuit (IC) design debugging process. After selecting the desired viewable graphic layout layers, the layout operator uses the mouse to traverse the pre-selected viewable graphical layout layers displayed, by changing the input scrolling pattern of the mouse to scroll forward, backward, diagonally and from side to side in a plurality of directions, where a curser on the layout screen will correspondingly move in the plurality of directions in the pre-selected viewable graphical layout layers on the layout screen corresponding to the movement of the mouse by the operator.

### TECHNICAL FIELD

The present invention relates generally to physical design, development and manufacturing of integrated circuits (IC) on semiconductor chips, for use in automated computing systems. More particularly, the present invention relates to an IC (IC) layout debugging method and tool.

### BACKGROUND

When conducting physical development of ICs, designers often face the problem of voluminous layers of IC topological information. When a layout person needs to trace a signal path, which traverses up and down a metal hierarchy of IC topology, all the viewable layers distract the layout person trying to conduct a debugging process involving only a few targeted layers. Although it is possible to turn on-and-off each layer individually or collectively, or to use a trace program to highlight the path, the excess of graphic information still presents a challenge to the layout person and fatigue, based on viewing and traversing the voluminous layers of IC topological information, affects the layout person adversely and causes the layout person to make mistakes and add re-work costs to the physical IC development process.

Therefore, the need exists for a navigation method and a navigation apparatus for use in debugging the design automation process of the physical development of IC's, where the method and tool decrease the information overload affects of having to view and traverse voluminous layers of IC topological information presented to a layout person performing debugging operations.

An additional need exists for providing a navigation methodology and tool in the IC design automation process that makes it easier for a layout person to traverse up and down a metal hierarchy of an IC topology.

Further the need exists for a navigation methodology and tool in the IC design automation process that reduces the incremental costs of IC physical development based on reducing the likelihood of the layout person making mistakes in the debugging process.

### SUMMARY OF THE INVENTION

A method and an apparatus are disclosed for z-axis display navigation in the design automation process of the physical design, development and manufacturing of integrated circuits include pre-selecting, by a layout operator/user, using a computer mouse connected to a computer workstation processor, to select a plurality of sets of viewable design data for a plurality of x-y planes of design in an IC. In addition, the layout operator/user uses the computer mouse to traverse the pre-selected graphic layers, representing the plurality of x-y planes of design, displayed in a design layout and by changing the input scrolling pattern of the mouse to scroll forward, backward, diagonally and from side to side in a plurality of directions, where a curser on the layout screen will correspondingly move in the plurality of directions in the pre-selected layers viewable on the layout screen corresponding to the movement of the mouse by the operator/user.

The pre-selection process is accomplished by the operator/user programming the computer workstation processor to perform at least one of storing in a first storing operation a set of first design data for a first x-y plane of a design and storing in a second storing operation a set of second design data for a second x-y plane of a design of the plurality of sets of viewable design data of the plurality of x-y planes of design.

The method and apparatus cause the display of various portions of views of the IC layout by displaying, in a first displaying operation, a first portion of the set of first design data and a first portion of the set of second design data, where the first portion of the set of second design data possibly being none of the set of second design data; displaying, in a second displaying operation, a second portion of the set of first design data, by an operator/user operating a computer mouse to control the second displaying operation of displaying the second portion of the set of first design data, where the second portion of the set of first design data is less than the first portion of the set of first design data; and displaying, in a third displaying operation, a second portion of the set of second design data, by the operator/user oerating the computer mouse to control the third displaying operation of displaying the second portion of the set of second design data, where the second portion of the set of second design data is greater than the first portion of the set of second design data.

### DETAILED DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings, which are meant to be exemplary, and not limiting, wherein:

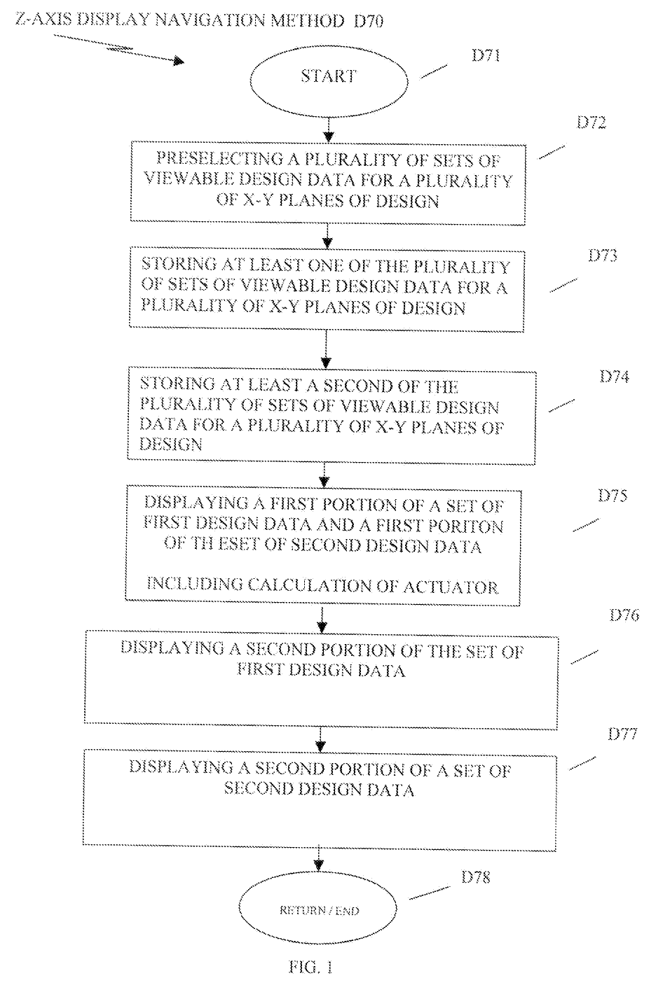

FIG. 1 illustrates operations in a method for z-axis display navigation in a design automation process of the physical design, development and manufacturing of integrated circuits, using a plurality of sets of viewable design data from a plurality of x-y planes of design.

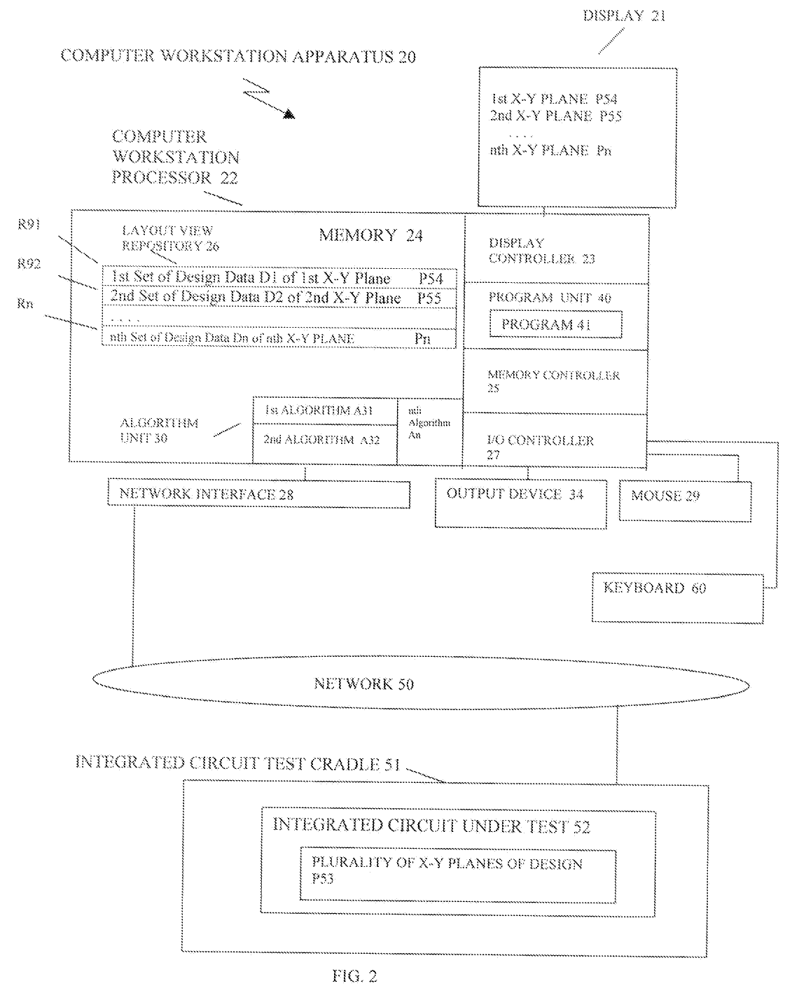

FIG. 2 illustrates the apparatus implementing the operations illustrated in FIG. 1.

### DETAILED DESCRIPTION

An exemplary embodiment of a computer systems software development service offering method and system is described in detail below. The disclosed exemplary embodiment is intended to be illustrative only, since numerous modifications and variations therein will be apparent to those of ordinary skill in the art. In reference to the drawings, like numbers will indicate like parts continuously throughout the view. Further, the terms “a”, “an”, “first”, “second” and “third” herein do not denote limitations of quantity, but rather denote the present of one or more of the referenced item(s).

Z-axis display navigation method D10 and a workstation apparatus 20 implementing the z-axis navigation method D10 are illustrated in FIGS. 1 and 2, respectively. The z-axis display navigation method D10 is used in a design automation process of the physical design, development and manufacturing of integrated circuits.

Referring to FIG. 2, computer workstation apparatus 20 includes computer workstation processor 22, which contains memory 24. Algorithm unit 30 resides in memory 24 and contains a plurality of algorithms including first algorithm A31 and second algorithm A32 up to nth algorithm An. Also, residing in computer workstation apparatus 20 is program unit 40, containing program 41. Memory 24 also contains layout view repository 26, where layout repository 26 contains a plurality of repository entry locations R91, R92 up to Rn, which hold pre-selected sets of x-y planes of design from a plurality of sets of viewable design data.

In addition, computer workstation apparatus 20 includes a combination of controllers including display controller 23, memory controller 25 and input/output (I/O) controller 27 and a combination of computer peripheral devices connected to computer workstation apparatus 20 including display 21, input devices including keyboard 60 and mouse 29, network interface 28, and output device 36. Network device 28 connects computer workstation processor 22 via network 50 to integrated circuit test cradle 51. An integrated circuit under test 52 is plugged into integrated circuit test cradle 51 to undergo a debugging exercise.

Integrated circuit under test 52 has a three dimensional layered topology of viewable design data including a plurality of x-y planes of design P53. Display 21 displays the plurality of x-y planes P53, when no pre-selected sets of x-y planes are desired for viewing by the operator/user. In the alternative, display 21 displays only the pre-selected set of x-y planes including first x-y plan P54, second x-y plane P55 up to nth x-y plane Pn which are desired for viewing by the user and display 21 does not display the plurality of x-y planes of design P53. By not displaying the plurality of x-y planes P53, user fatigue is reduced, causing the user to make fewer mistakes in exercising the IC under test 52, during a debugging stage of the IC design and development process.

Referring to FIG. 1, at operation start D71, the user activates program 41 where z-axis display navigation method D70 stored as program code. The user activates program 41 and performs other selections in z-axis display navigation method D70 by making selections using either keyboard 60 or mouse 29. At operation D71, the user makes the selection to activate program 41; thus, causing program 41 to be executed by computer workstation processor 22. At operation D72, the user pre-selects, from the plurality of viewable design data, a set of x-y planes of design. Included in the set of x-y planes of design are a first x-y plan P54 and a second x-y plane P55 up to an nth x-y plane Pn.

After, pre-selecting the set of x-y planes of design, the user operates mouse 29 to traverse select graphic layers represented by first x-y plan P54 and a second x-y plane P55 up to an nth x-y plane Pn displayed in a design layout and by changing the input scrolling pattern of mouse 29 to scroll forward, backward, diagonally and from side to side in a plurality of directions, where a curser on the layout screen will correspondingly move in the plurality of directions in the pre-selected layers viewable on the layout screen corresponding to the movement of the mouse by the operator/user.

The pre-selection process is accomplished by the operator/user programming program 41 to view only selected viewable graphical layers of the integrated circuit under test 52, where the programming is accomplished by the operator/user entering the pre-selected sets of x-y planes of design data at operation D72 into computer workstation processor 22, and where at operation D73, program 41 calls a first algorithm to accesses the sets of x-y planes of design data and causes the accessed sets of x-y planes of design data to be stored in repository entry locations R91, R92 through Rn of layout view repository 26, where the storing of sets of x-y plane design data includes storing in a first storing operation D73, into layout view repository 26, repository entry location R91, a set of first design data D1 for a first x-y plane P54 of a design from the plurality of sets of viewable design data of the plurality of x-y planes of design P53 and storing in a second storing operation D74, in layout view repository 26, repository entry location R92, a set of second design data D2 for a second x-y plane P55 of a design of the plurality of sets of viewable design data of the plurality of x-y planes of design P53. The storing operations can store design data up to a set of nth design data for an nth x-y plane Pn, in an nth repository entry location Rn, where the value of n is limited to the maximum number of layout views based on design choices along with the physical size of the integrated circuit under test 52.

Program 41 calls a second algorithm that causes a display of various portions of view of the IC layout on display 21. The displayed views of portions of the IC layout represent the pre-selected sets of x-y plane design data stored in layout view repository 26 by displaying on display 21, in first displaying operation D75, a first portion of the set of first design data and a first portion of the set of second design data. Therefore, in first displaying operation D75, the first portion of the set of second design data possibly being none of the set of second design data.

The second algorithm causes a second displaying operation D76, where a second portion of the set of first design data is displayed by display 21. Furthermore, in second displaying operation 76, the second portion of the set of first design data is less than the first portion of the set of first design data.

Further, the second algorithm causes display 21 to display in a third displaying operation D77, a second portion of the set of second design data. Furthermore, in third displaying operation D77, the second portion of the set of second design data is greater than the first portion of the set of second design data. Therefore, the execution of program 41 by computer workstation processor 22, causes computer workstation process 22 to implement the embodiment of z-axis display navigation method D70 and thus, provides an engineering design aid that the user has programmed to perform the useful, concrete and tangible result of controlling mouse 29 to traverse the pre-selected graphical layout layers displayed by display 21 and conduct a debugging operation of the integrated circuit under test 52, without the distraction from voluminous layers of IC topological information and resulting information overload while traversing the plurality of x-y planes of design P53.

At operation D78, z-axis display navigation method D70 either returns to operation D72 where additional x-y planes of design can be pre-selected, as well as already viewed x-y planes of design can be de-selected, and where additional iterations of the exercising of integrated circuit under test 52 are performed by the operator/user. In the alternative at operation D78, the user can end operation of z-axis display navigation method D70, by deactivating program 41 and ending the design debugging session.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular exemplary embodiment disclosed as the best mode contemplated for carrying out this disclosure, but that the disclosure will include all embodiments falling within the scope of the appended claims.

What is claimed is:

1. A method for z-axis display navigation in a design automation exercise of an integrated circuit under test, the method comprising:
pre-selecting, by a user, using a computer input device, a plurality of sets of viewable design data for a plurality of x-y planes of a design;
performing one or more of storing in a first storing operation a set of first design data for a first x-y plane of design and storing in a second storing operation a set of second design data for a second x-y plane of design of the plurality of sets of viewable design data from the plurality of x-y planes of the design;
displaying, in a first displaying operation, a first portion of the set of first design data and a first portion of the set of second design data, where the first portion of the set of second design data being none of the set of second design data;
displaying, in a second displaying operation, a second portion of the set of first design data, by an operator operating a computer mouse to control the second displaying operation of displaying the second portion of the set of first design data, where the second portion of the set of first design data is less than the first portion of the set of first design data; and
displaying, in a third displaying operation, a second portion of the set of second design data, where the second portion of the set of second design data is greater than the first portion of the set of second design data, and where the user controls the computer input device to perform the useful, concrete and tangible result traversing the pre-selected graphical layout layers displayed and conducting a debugging operation of the integrated circuit under test, without distractions from voluminous layers of IC topological information, based on having to traverse the plurality of x-y planes of design.

2. The method according to claim 1, further comprising performing one of ending the z-axis navigation method and repeating the z-axis navigation method by using one of different pre-selected x-y planes of design and previously selected x-y planes of design, by the user.

3. An apparatus for z-axis display navigation in a design automation exercise of an integrated circuit under test, the apparatus comprising:
a computer workstation containing a computer workstation processor;
a combination of computer peripheral devices connected to the computer workstation, where the combination of peripheral devices include a display, a set of input devices including a keyboard and a mouse, an output device, and a network interface, where the network interface connects to a network, where the network is connected to an integrated circuit test cradle containing an integrated circuit under test, and the integrated circuit under test contains a plurality of x-y planes of design;
a combination of controllers reside in the computer workstation, where the combination of controllers include a display controller, a memory controller and an input/output controller;
a memory, a program unit and an algorithm unit reside in the computer workstation processor, where the memory contains a layout view repository, the algorithm unit contains a plurality of algorithms and the program unit contains a program that when executed by the computer workstation processor, causes the computer workstation processor to perform the operations of:
pre-selecting, by a user, using one of the keyboard and the mouse, a plurality of sets of viewable design data for a plurality of x-y planes of a design;
performing one or more of storing in a first storing operation a set of first design data for a first x-y plane of design and storing in a second storing operation a set of second design data for a second x-y plane of design of the plurality of sets of viewable design data from the plurality of x-y planes of the design;
displaying, in a first displaying operation, a first portion of the set of first design data and a first portion of the set of second design data, where the first portion of the set of second design data being none of the set of second design data;
displaying, in a second displaying operation, a second portion of the set of first design data, where the second portion of the set of first design data is less than the first portion of the set of first design data; and
displaying, in a third displaying operation, a second portion of the set of second design data, where the second portion of the set of second design data is greater than the first portion of the set of second design data, and where the user controls the mouse to perform the useful, concrete and tangible result traversing the pre-selected graphical layout layers displayed and conducting a debugging operation of the integrated circuit under test, without distractions from voluminous layers of IC topological information, based on having to traverse the plurality of x-y planes of design.

4. The apparatus according to claim 1, where the program contained in the program unit causes the computer workstation processor to perform one of ending the z-axis navigation method and repeating the z-axis navigation method by using one of different pre-selected x-y planes of design and previously selected x-y planes of design, by the user.
